(19) United States
(12) Patent Application Publication
(10) Pub. No.: US 2013/0229832 A1
(43) Pub. Date: Sep. 5, 2013

(54) CONTROLLING A FLYBACK CONVERTER FOR USE WITH A COMPUTER SYSTEM

(71) Applicants: Bharatkumar K. Patel, San Jose, CA (US); Abby Cherian, Sunnyvale, CA (US); Manisha P. Pandya, Sunnyvale, CA (US); Prasad S. Joshi, Irvine, CA (US)

(72) Inventors: Bharatkumar K. Patel, San Jose, CA (US); Abby Cherian, Sunnyvale, CA (US); Manisha P. Pandya, Sunnyvale, CA (US); Prasad S. Joshi, Irvine, CA (US)

(73) Assignee: APPLE INC., Cupertino, CA (US)

(21) Appl. No.: 13/490,297

(22) Filed: Jun. 6, 2012

Related U.S. Application Data
(60) Provisional application No. 61/606,237, filed on Mar. 2, 2012.

(51) Int. Cl. H02M 3/335

(52) U.S. Cl. 363/21.12

(57) ABSTRACT

The disclosed embodiments provide an apparatus that controls a flyback converter for use with a computer system. During operation, the apparatus senses an output voltage and output current of the flyback converter. The apparatus then switches a mode for controlling the flyback converter from a discontinuous mode to a continuous mode based on the sensed output voltage and the sensed output current.

### RELATED APPLICATION

This application hereby claims priority under 35 U.S.C. §119 to U.S. Provisional Application No. 61/606,237, entitled “Controlling a Flyback Converter for Use with a Computer System,” by Bharatkumar K. Patel, Abby Cherian, Manisha P. Pandya and Prasad S. Joshi, filed 2 Mar. 2012 (Atty. Docket No.: APL-P13505USP1).

### BACKGROUND

1. Field

The present embodiments relate to techniques for controlling a flyback converter. More specifically, the present embodiments relate to techniques for controlling a flyback converter for use with a computer system.

2. Related Art

Adapters for powering portable computer systems such as laptop computers often use flyback converters due to their low cost and smaller package size. However, computer systems, including laptop computers, are increasingly being manufactured with chips capable of substantially raising their power demands for short periods of time (e.g., by entering a “turbo” mode). When these chips enter a high power demand state, the required power may temporarily exceed the output power capabilities of a flyback converter, resulting in saturation of the transformer core, or causing power limiting circuits to limit the output power of the adapter. This may impact the performance of the computer system and result in a poor user experience.

### BRIEF DESCRIPTION OF THE FIGURES

FIG. 1 shows a flyback converter in accordance with an embodiment.

FIG. 2 shows a flowchart depicting the process for controlling a flyback converter in accordance with an embodiment.

In the figures, like reference numerals refer to the same figure elements

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

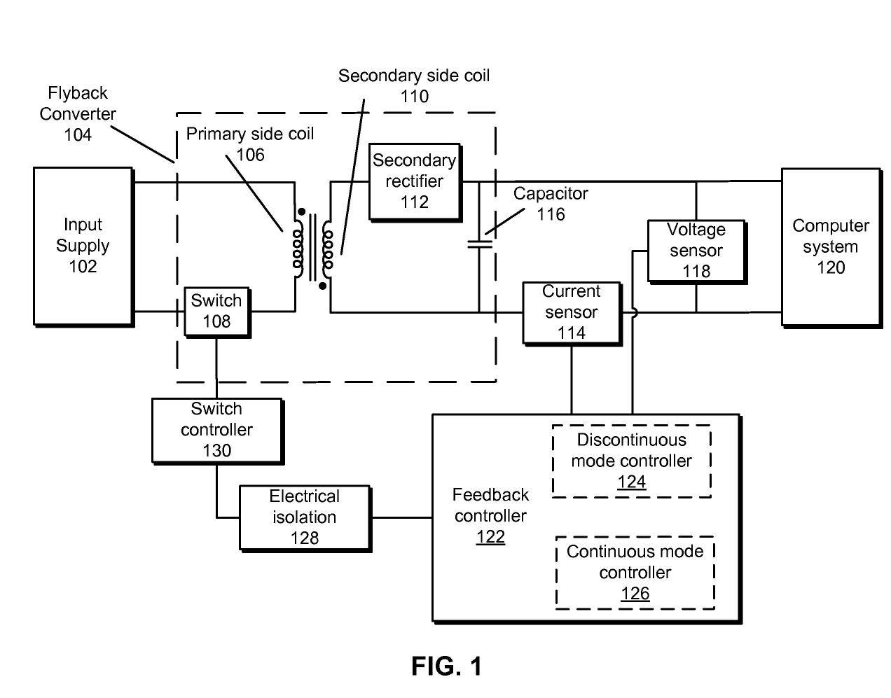

FIG. 1 depicts a flyback converter in accordance with an embodiment. Input supply 102 is coupled to flyback converter 104 which is coupled through current sensor 114 and across voltage sensor 118 to computer system 120. Flyback converter 104 includes primary side coil 106, switch 108, and secondary side coil 110 coupled to secondary rectifier 112 and across capacitor 116. Feedback controller 122 is coupled to current sensor 114, voltage sensor 118, and switch 108 through electrical isolation 128 and switch controller 130. Feedback controller 122 includes discontinuous mode controller 124 and continuous mode controller 126.

Input supply 102 can be any supply used to input electrical power into a flyback converter, including but not limited to a full-bridge rectifier or a half-bridge rectifier connected to household alternating current (AC) electricity. Primary side coil 106 and secondary side coil 110 can be any flyback transformer coils with the appropriate specifications (e.g., peak and average power) that are generally used in a flyback converter. Switch 108 can be any switch for use in a flyback converter and can include but is not limited to a field effect transistor (FET). Capacitor 116 can be any appropriate capacitor generally used for a flyback converter.

Voltage sensor 118 can be any voltage sensor that can sense the output voltage of a flyback converter and transmit a signal to feedback controller 122. Voltage sensor 118 may be implemented in any technology including but not limited to analog or digital technology, or a combination thereof, and in some embodiments includes a voltage divider containing two or more resistors.

Current sensor 114 can be any current sensor that can sense the output current of a flyback converter and transmit a signal to feedback controller 122. Current sensor 114 can be implemented in any technology, including but not limited to analog or digital technology, or a combination thereof, and in some embodiments includes a current sense resistor which is coupled at each end to feedback controller 122.

Computer system 120 can be any computing system that uses electrical power that can be supplied by a flyback converter. Computer system 120 may include but is not limited to a laptop computer, a tablet computer, a smartphone, or a desktop computer.

Electrical isolation 128 electrically isolates voltages and signals on the secondary side of flyback converter 104 from those on the primary side. Electrical isolation 128 may be implemented in any technology including but not limited to one or more optocouplers.

Switch controller 130 may be implemented in any technology, including any combination of analog and digital circuitry, and hardware and/or software. In some embodiments, switch controller 130 is implemented as an integrated circuit chip and may also include one or more discrete components such as capacitors or resistors. In other embodiments, switch controller 130 and electrical isolation 128 are implemented in feedback controller 122. As will be discussed below, switch controller 130 controls switch 108 based on one or more analog and/or digital signals through electrical isolation 128 from feedback controller 122.

Feedback controller 122 can be implemented in any technology and may include but is not limited to any combination of hardware, software, and analog and/or digital components, and may include one or more processors, and volatile and/or non-volatile memory. Feedback controller 122 receives input from current sensor 114 and voltage sensor 118, and includes discontinuous mode controller 124 and continuous mode controller 126. Note that both discontinuous mode controller 124 and continuous mode controller 126 can receive input from current sensor 114 and voltage sensor 118.

In some embodiments, discontinuous mode controller 124 and continuous mode controller 126 are each separate controllers implemented in feedback controller 122. Discontinuous mode controller 124 and continuous mode controller 126 may each be implemented in any combination of analog and digital components and may include any combination of hardware and software. In some embodiments, discontinuous mode controller 124 and continuous mode controller 126 each implement separate digital proportional integral derivative (PID) controllers. Note that discontinuous mode controller 124 and continuous mode controller 126 may share one or more resources in feedback controller 122 such as a processor and/or memory.

During operation, feedback controller 122 uses the output from either discontinuous mode controller 124 or continuous mode controller 126 to control flyback converter 104 using switch controller 130 to control switch 108. When feedback controller 122 uses the output of discontinuous mode controller 124 to control flyback converter 104, flyback converter 104 is controlled in a discontinuous mode and feedback controller 122 sends a voltage control feedback signal generated by discontinuous mode controller 124 through electrical isolation 128 to switch controller 130 to control switch 108. This controls flyback converter 104 in a voltage mode control that controls for the voltage output of flyback converter 104. Discontinuous mode controller 124 may also control switch 108 through switch controller 130 to be in a quasi-resonant, zero-voltage and zero-current switching mode.

When feedback controller 122 uses the output of continuous mode controller 126 to control flyback converter 104, flyback converter 104 is controlled in a continuous mode. Feedback controller 122 sends a current control feedback signal generated by continuous mode controller 126 through electrical isolation 128 to switch controller 130 to control switch 108. This controls flyback converter 104 in a current mode control that controls for the current output of flyback converter 104. Feedback controller 122 may also send a signal to switch controller 130 through electrical isolation 128 that controls switch controller 130 to operate switch 108 at a predetermined higher frequency than switch 108 operates at when flyback converter 104 is in the discontinuous mode. The predetermined high frequency may be determined based on information including but not limited to the output voltage and current desired from flyback converter 104, and the specifications of input supply 102. For example in some embodiments, when flyback converter 104 is in the discontinuous mode switch 108 may operated at a frequency in the range from 60 kHz to 100 kHz, while when flyback converter 104 is in the continuous mode the frequency of operation of switch 108 may be 120 kHz. Note that the power output from flyback converter 104 may be larger when it is controlled by continuous mode controller 126 than when it is controlled by discontinuous mode controller 124. Additionally, note that in some embodiments, when feedback controller 122 switches from using continuous mode controller 126 to using discontinuous mode controller 124 to control switch controller 130, feedback controller 122 may also send a signal to switch controller 130 through electrical isolation 128 to stop operating at the predetermined higher frequency and to resume operating in a quasi-resonant mode as described above.

Secondary rectifier 112 may be any rectifier generally used as a secondary rectifier in a flyback converter. In some embodiments, secondary rectifier 112 is a synchronous rectifier and is coupled through a connection (not shown) to feedback controller 122. In these embodiments, feedback controller 122 can send a signal to the synchronous rectifier of secondary rectifier 112 to turn off and thus act like a passive rectifier when feedback controller 122 switches from using discontinuous mode controller 124 to using continuous mode controller 126 to control flyback converter 104. Then, when feedback controller 122 switches from using continuous mode controller 126 to using discontinuous mode controller 124 to control flyback converter 104, feedback controller 122 can send a signal to secondary rectifier 112 to turn on the synchronous rectifier in secondary rectifier 112 so that it again works as synchronous rectifier.

An embodiment operates as follows. Electrical power is supplied by input supply 102 to flyback converter 104 and converted to a voltage level for use by computer system 120. During normal operation of computer system 120 (e.g., when it is not in a high power usage state such as a “turbo” mode) feedback controller 122 controls flyback converter 104 using the output from discontinuous mode controller 124.

When computer system 120 increases its demand for power, such as by entering a “turbo” mode, computer system 120 will start to draw more current from flyback converter 104. As more current is drawn from flyback converter 104, eventually the voltage from flyback converter 104 will start to fall as the power demanded by computer system 120 starts to exceed the power that can be delivered from flyback converter 104 while regulating the output voltage of flyback converter 104 at the desired level. When feedback controller 122 senses that the current from flyback converter 104 has exceeded a predetermined current and that the voltage from flyback converter 104 has fallen below a predetermined voltage, then feedback controller 122 will switch from using discontinuous mode controller 124 to control flyback converter 104 to using continuous mode controller 126 to control flyback converter 104.

The predetermined voltage and predetermined current may be selected as follows. In some embodiments, when flyback converter 104 is controlled by feedback controller 122 using discontinuous mode controller 124 in a quasi-resonant voltage mode control, the output of flyback converter 104 is regulated to be within a predetermined value or percentage (e.g., 5%) of its nominal output. The predetermined voltage may then be selected to be equal to or less than a voltage that falls outside the nominal regulated output voltage of flyback converter 104 (e.g., 95% or less of the nominal voltage).

The predetermined current value may be selected to be the current drawn from flyback converter 104 that would result in the voltage output of flyback converter 104 falling below the nominal voltage regulation of flyback converter 104 (e.g., 95%), or it may be a fixed percentage higher than the maximum output current that can be supplied at the nominal output voltage by flyback converter 104 when being controlled by discontinuous mode controller 124. For example, for a 60 watt flyback converter, with a nominal output voltage of 16.5 volts and a nominal steady-state peak current of 3.6 amps, the predetermined voltage may be set to be at or less than 15.675 volts (e.g., 95% of 16.5 volts), and the predetermined current may be set to be in the range of 5.4 to 7.2 amps (e.g., 50% to 100% above the nominal steady-state peak current).

Note that in some embodiments the predetermined voltage and predetermined current may be determined based on measurements of current and voltage during operational or other testing of flyback converter 104 while powering a computer system performing a series of operations to mimic power usage profiles of a computer system during use in the field. The predetermined voltage and predetermined current may then be selected based on factors including but not limited to thermal or other operation characteristics of flyback converter 104 and/or input supply 102 and the user experience while operating the computer system.

When the voltage sensed by feedback controller 122 using voltage sensor 118 is less than the predetermined voltage, and the current sensed by feedback controller 122 using current sensor 114 is above the predetermined current, then feedback controller 122 switches from using discontinuous mode controller 124 to control flyback converter 104 to using continuous mode controller 126 to control flyback converter 104.

Then, while feedback controller 122 is using continuous mode controller 126 to control flyback converter 104, if the voltage sensed by feedback controller 122 using voltage sensor 118 is greater than the predetermined voltage or the current sensed by feedback controller 122 using current sensor 114 is below the predetermined current, then feedback controller 122 switches from using continuous mode controller 126 to control flyback converter 104 to using discontinuous mode controller 124 to control flyback converter 104. Note that in some embodiments one set of values for the predetermined voltage and predetermined current may be used by feedback controller 122 to switch from using discontinuous mode controller 124 to continuous mode controller 126 to control flyback converter 104, and another set of values may be used for switching from using continuous mode controller 126 to discontinuous mode controller 124 to control flyback converter 104.

In some embodiments feedback controller 122 limits the amount of time that feedback controller 122 can use continuous mode controller 126 to control flyback converter 104. The duration of this time period may be determined by one or more of the thermal and electrical characteristics of flyback converter 104 and/or input supply 102, and in some embodiments may be 10 milliseconds. When this time period expires, feedback controller 122 may switch to using discontinuous mode controller 124 to control flyback converter 104. Additionally, in some embodiments when this time period expires, a second time period begins during which feedback controller 122 prevents continuous mode controller 126 from controlling flyback converter 104. This second time period may be determined based on thermal characteristics of flyback converter 104 and/or input supply 102, and may be selected to be long enough to prevent flyback converter 104 and/or input supply 102 from overheating due to operating in a continuous mode controlled by continuous mode controller 126. In some embodiments the second time period may be 300 milliseconds. Additionally, in some embodiments, if the current from flyback converter 104 sensed by feedback controller 122 using current sensor 114 exceeds a predetermined threshold, then feedback controller 122 may shut off flyback converter 104 and/or input supply 102 using a connection not shown in FIG. 1.

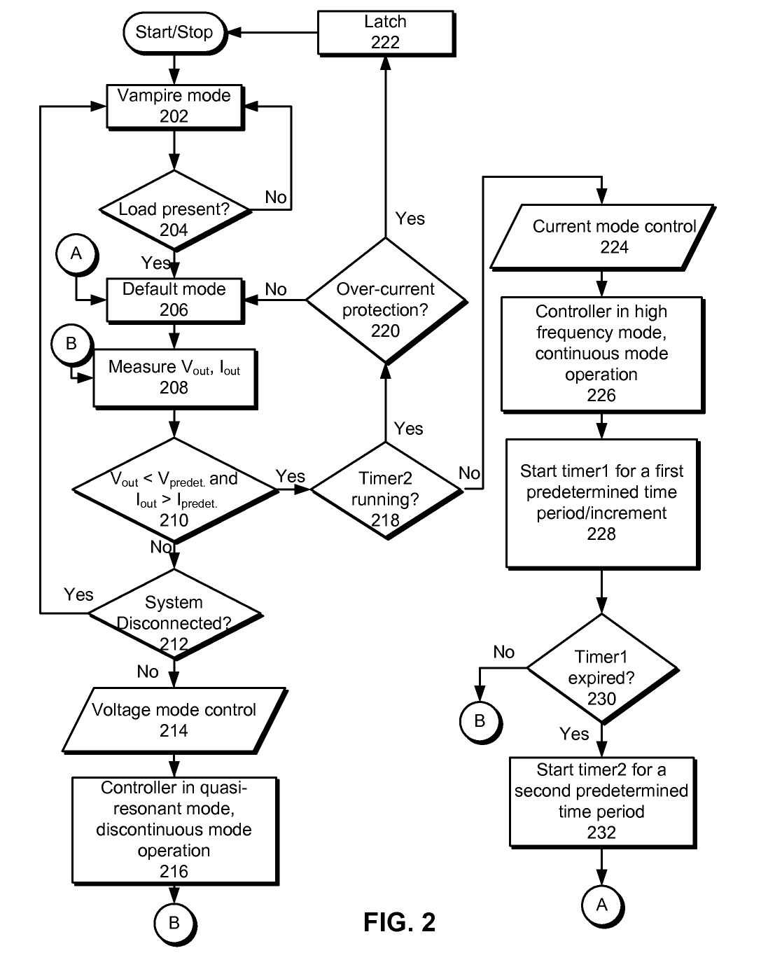

FIG. 2 shows a flowchart depicting the process for controlling a flyback converter in an adapter for use with a computer system in accordance with an embodiment. In step 202, the power adapter is in a vampire mode. At step 204, if no load is present (e.g. if the adapter is not plugged in to a computer system), then the process returns to step 202, while if a load is present the process continues to step 206 and enters a default mode. In the default mode (step 206), the flyback converter is controlled by a feedback controller in the adapter in a voltage-mode controlled quasi-resonant discontinuous mode.

The output voltage and output current of the flyback converter are then measured (step 208). If the output voltage is not less than a predetermined voltage or the output current is not greater than a predetermined current (step 210), the process continues to step 212. If the computer system is disconnected (step 212), then the process returns to step 202. If the computer system is not disconnected (step 212), then the feedback controller is put into voltage mode control (step 214), and quasi-resonant mode and discontinuous mode (216) if it is not already in these modes. The process then returns to step 208.

At step 210, if the output voltage is less than the predetermined voltage and the output current is greater than the predetermined current, then the process continues to step 218. At step 218, if timer2 is still running then the process continues to step 220. At step 220, if an over-current protection fault is present, then the process continues to step 222 and turns the adapter off (e.g., latches it), and the process stops. At step 220, if an over-current protection fault is not present, then the process continues to step 206.

At step 218, if timer2 is not still running (e.g., timer2 has expired), then the feedback controller is put into current mode control (step 224) and controlled in a continuous mode and at a higher frequency relative to the quasi-resonant, discontinuous mode (step 226). Then, timer1 is started for a first predetermined time period if it has not already been started; if timer1 has already been started, it is incremented (step 228). Then, if timer1 has not expired, the process returns to step 208. If timer1 has expired (step 230), then timer2 is started for a second predetermined time period (step 232) and the process returns to step 206. Note that in some embodiments the first predetermined time period for timer1 is 10 milliseconds and the second predetermined time period for timer2 is 300 milliseconds.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for controlling a flyback converter for use with a computer system, the method comprising:
sensing an output voltage of the flyback converter;
sensing an output current of the flyback converter; and
switching a mode for controlling the flyback converter from a discontinuous mode to a continuous mode based on the sensed output voltage and the sensed output current.

2. The method of claim 1, wherein controlling the flyback converter in the discontinuous mode involves controlling the flyback converter in a constant voltage mode.

3. The method of claim 1, wherein controlling the flyback converter in the continuous mode involves controlling the flyback converter in a constant current mode.

4. The method of claim 1, wherein switching the mode for controlling the flyback converter from the discontinuous mode to the continuous mode based on the sensed output voltage and the sensed output current involves switching the mode for controlling the flyback converter from the discontinuous mode to the continuous mode when the sensed output voltage is less than a predetermined voltage and the sensed output current is greater than a predetermined current.

5. The method of claim 1, wherein a controller for controlling the flyback converter includes a continuous mode controller and a discontinuous mode controller, and switching the mode for controlling the flyback converter from the discontinuous mode to the continuous mode involves switching an output of the controller from an output of the discontinuous mode controller to an output of the continuous mode controller.

6. The method of claim 1, further including:
switching the mode for controlling the flyback converter from the continuous mode to the discontinuous mode based on the sensed output voltage and the sensed output current.

7. The method of claim 1, further including:
switching the mode for controlling the flyback converter from the continuous mode to the discontinuous mode after a predetermined time period.

8. The method of claim 1, wherein a frequency of operation of the flyback converter in the continuous mode is higher than a frequency of operation of the flyback converter in the discontinuous mode.

9. A non-transitory computer-readable storage medium containing instructions that, when executed by a processing subsystem in a controller, cause the controller to perform a method for controlling a flyback converter for use with a computer system, the method comprising:
sensing an output voltage of the flyback converter;
sensing an output current of the flyback converter; and
switching a mode for the controller from a discontinuous mode to a continuous mode based on the sensed output voltage and the sensed output current.

10. The storage medium of claim 9, wherein controlling the flyback converter in the discontinuous mode involves controlling the flyback converter in a constant voltage mode.

11. The storage medium of claim 9, wherein controlling the flyback converter in the continuous mode involves controlling the flyback converter in a constant current mode.

12. The storage medium of claim 9, wherein switching the mode for controlling the flyback converter from the discontinuous mode to the continuous mode based on the sensed output voltage and the sensed output current involves switching the mode for controlling the flyback converter from the discontinuous mode to the continuous mode when the sensed output voltage is less than a predetermined voltage and the sensed output current is greater than a predetermined current.

13. The storage medium of claim 9, wherein:
the controller includes a continuous mode controller and a discontinuous mode controller, and switching the mode for the controller from the discontinuous mode to the continuous mode involves switching an output of the controller from an output of the discontinuous mode controller to an output of the continuous mode controller.

14. The storage medium of claim 9, further including:
switching the mode for controlling the flyback converter from the continuous mode to the discontinuous mode based on the sensed output voltage and the sensed output current.

15. The storage medium of claim 9, further including:
switching the mode for controlling the flyback converter from the continuous mode to the discontinuous mode after a predetermined time period.

16. The storage medium of claim 9, wherein a frequency of operation of the flyback converter in the continuous mode is higher than a frequency of operation of the flyback converter in the discontinuous mode.

17. An apparatus for controlling a flyback converter for use with a computer system, comprising:
a first controller configured to control the flyback converter in a discontinuous mode;
a second controller configured to control the flyback converter in a continuous mode; and
a control mode selection module coupled to the first controller and to the second controller, and configured to receive an output voltage of the flyback converter and an output current of the flyback converter, and to select a controller for the flyback converter from the first controller and the second controller based on the output voltage and output current.

18. The apparatus of claim 17, wherein the first controller is further configured to control the flyback converter in a constant voltage mode.

19. The apparatus of claim 17, wherein the second controller is further configured to control the flyback converter in a constant current mode.

20. The apparatus of claim 17, wherein when selecting the controller for the flyback converter based on the output voltage and output current, the control mode selection module is configured to:
select the second controller when the output voltage is less than a predetermined voltage and the output current is greater than a predetermined current.

21. The apparatus of claim 17, wherein when selecting the controller for the flyback converter based on the output voltage and output current, the control mode selection module is configured to:
select the first controller when the output voltage is greater than a predetermined voltage and the output current is less than a predetermined current.

22. The apparatus of claim 17, wherein when the controller selected by the control selection module is the second controller and a predetermined time period has elapsed since the second controller was selected by the control selection module, the control selection module is further configured to select the first controller.

23. The apparatus of claim 17, wherein the second controller is configured so that a frequency of operation of the flyback converter when controlled by the second controller is higher than a frequency of operation of the flyback converter when controlled by the first controller.
